(19) United States
(12) Patent Application Publication
(10) Pub. No.: US 2025/0212083 A1
(43) Pub. Date: Jun. 26, 2025

(54) INTELLIGENT USER BURST TRAFFIC HANDLING ON A MOVING VIRTUAL NETWORK

(71) Applicant: Intel Corporation, Santa Clara, CA (US)

(72) Inventors: Harish Mitty, Bangalore (IN); Smit Kapila, Bangalore (IN); Balvinder Pal Singh, Bhilai (IN); Sandeep Masti, Bengaluru (IN); Jayprakash Thakur, Bangalore (IN); Prasanna Ramarao Banavara, Bangalore (IN)

(21) Appl. No.: 18/390,044

(22) Filed: Dec. 20, 2023

(51) Int. Cl. H04W 36/32; H04W 36/30

(52) U.S. Cl. CPC H04W 36/32; H04W 36/302

(57) ABSTRACT

A network device for use in an Open Radio Access Network (O-RAN) base station or a network-side device for other radio access technology (RAT) includes communication circuitry. The communication circuitry can receive communications from a user equipment (UE) or group of UEs and from a plurality of cells. The network device can include processing circuitry coupled to the communication circuitry. The processing circuitry can receive data, over the communication circuitry, indicating a speed of the UE and data indicating a mobile cell speed of at least one of the plurality of cells. The processing circuitry receive an indication that the speed of the UE is within a threshold of the mobile cell speed and responsive to this indication, provide an instruction to the UE to connect to the mobile cell.

### TECHNICAL FIELD

Aspects pertain to wireless communications. Some aspects relate to camping user devices on cells based on mobility and signal strength.

### BACKGROUND

Mobile users often make use of large-scale public transport, for example trains, which can transport hundreds or even thousands of users. When trains arrive at train depots, sudden but temporary surges may overwhelm the communication networks in the train depots and in surrounding buildings or neighborhoods as the train passengers attempt to connect.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an exemplary architecture of a network in which some aspects of the disclosure may be implemented.

FIG. 1B illustrates a non-roaming 5G system architecture in accordance with some aspects.

FIG. 2 illustrates an example of an Open RAN (O-RAN) system architecture in which some aspects of the disclosure may be implemented.

FIG. 3 illustrates a logical architecture of the O-RAN system of FIG. 2, in accordance with some aspects.

FIG. 4 illustrates a system in which example aspects can be implemented.

FIG. 5 illustrates signal flow for implementing aspects of the disclosure.

FIG. 6 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

### Systems and Networks

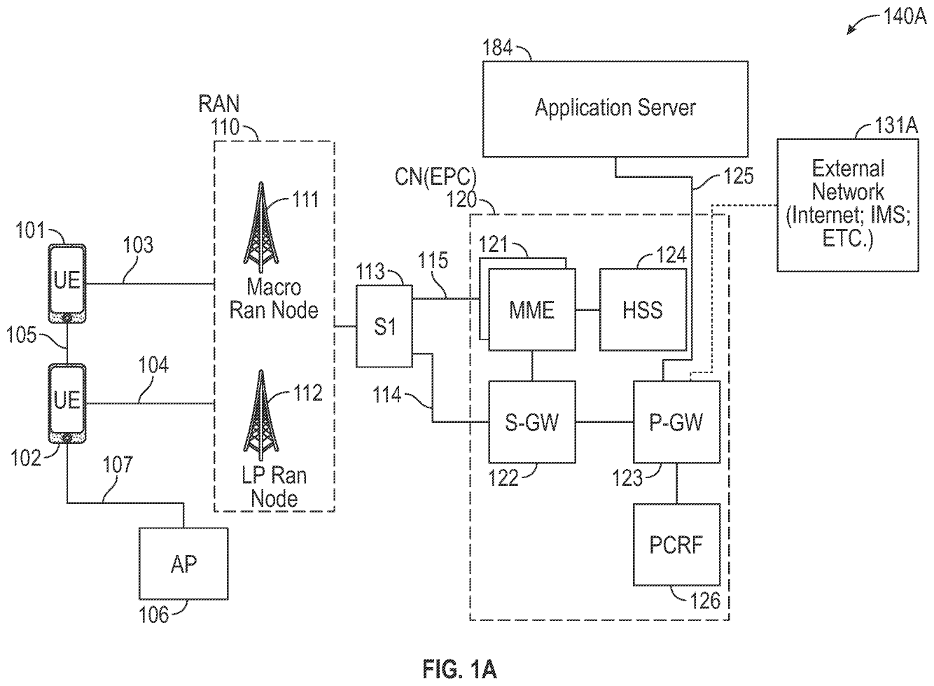

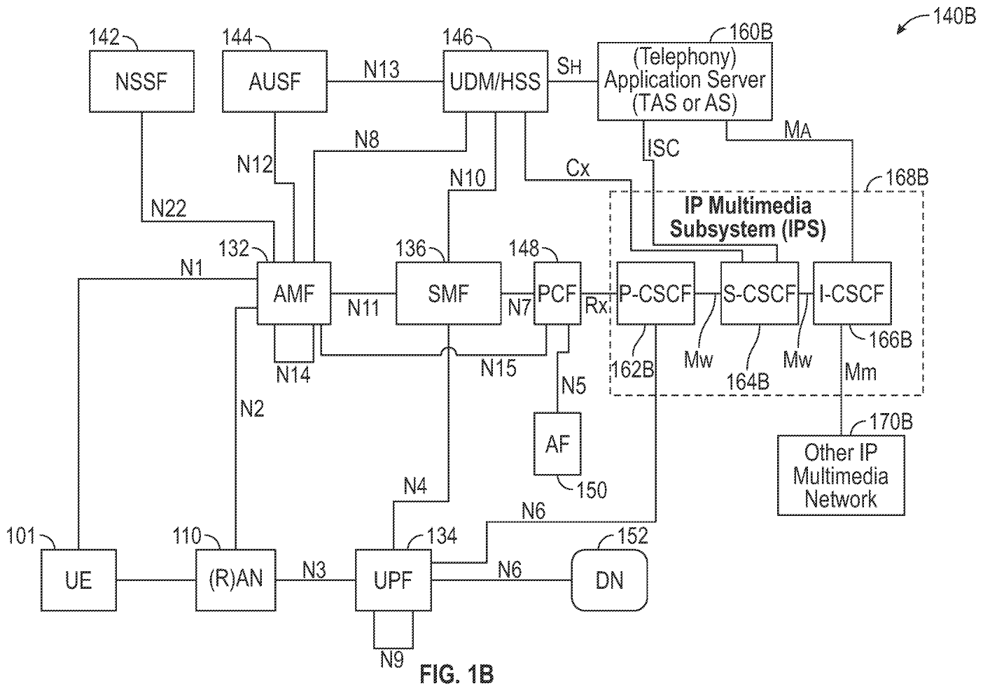

FIG. 1A illustrates an architecture of a network in which some aspects of the disclosure may be implemented. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein. Any of the radio links described herein (e.g., as used in the network 140A or any other illustrated network) may operate according to any exemplary radio communication technology and/or standard. FIG. 1B illustrates a non-roaming 5G system architecture in accordance with some aspects and is described in more detail later herein.

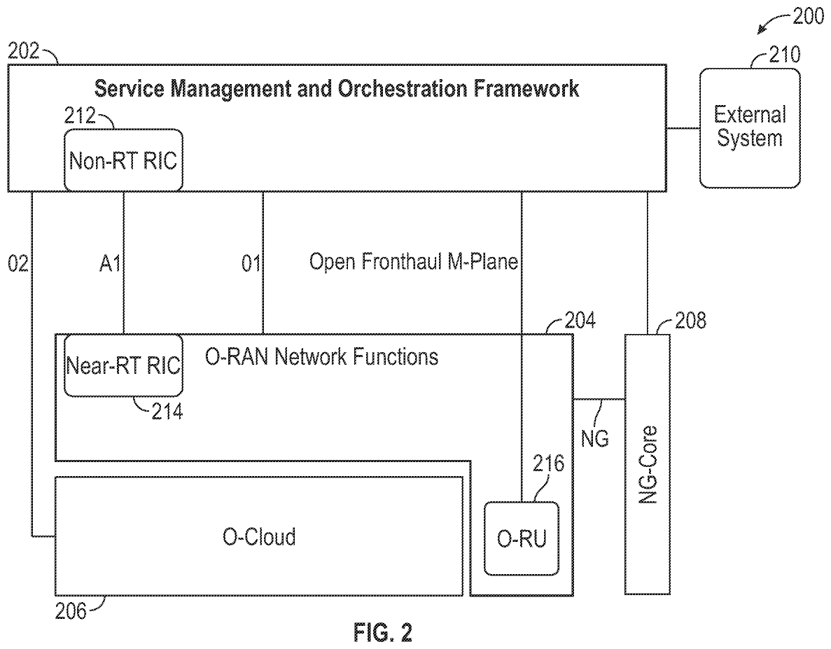

Referring now to FIG. 2, FIG. 2 provides a high-level view of an Open-Radio Access Network (O-RAN) architecture 200, which can also be referred to as virtualized RAN (V-RAN). The O-RAN architecture 200 includes four O-RAN defined interfaces—namely, the A1 interface, the O1 interface, the O2 interface, and the Open Fronthaul Management (M)-plane interface—which connect the Service Management and Orchestration (SMO) framework 202 to O-RAN network functions (NFs) 204 and the O-Cloud 206. The SMO 202 also connects with an external system 210, which provides additional configuration data to the SMO 202. FIG. 2 also illustrates that the A1 interface connects the O-RAN Non-Real Time (RT) RAN Intelligent Controller (RIC) 212 in or at the SMO 202 and the O-RAN Near-RT RIC 214 in or at the O-RAN NFs 204. The O-RAN NFs 204 can be virtualized network functions (VNFs) such as virtual machines (VMs) or containers, sitting above the O-Cloud 206 and/or Physical Network Functions (PNFs) utilizing customized hardware. All O-RAN NFs 204 are expected to support the O1 interface when interfacing with the SMO framework 202. The O-RAN NFs 204 connect to the NG-Core 208 via the NG interface (which is a 3GPP-defined interface). The Open Fronthaul M-plane interface between the O-RAN Distributed Unit (DU) and the O-RAN Radio Unit (O-RU) 216 supports the O-RU 216 management in the O-RAN hybrid model. The O-RU's termination of the Open Fronthaul M-plane interface is an optional interface to the SMO 202 that is included for backward compatibility purposes and is intended for management of the O-RU 216 in hybrid mode only. The O-RU 216 termination of the O1 interface towards the SMO 202 is specified in ORAN standards.

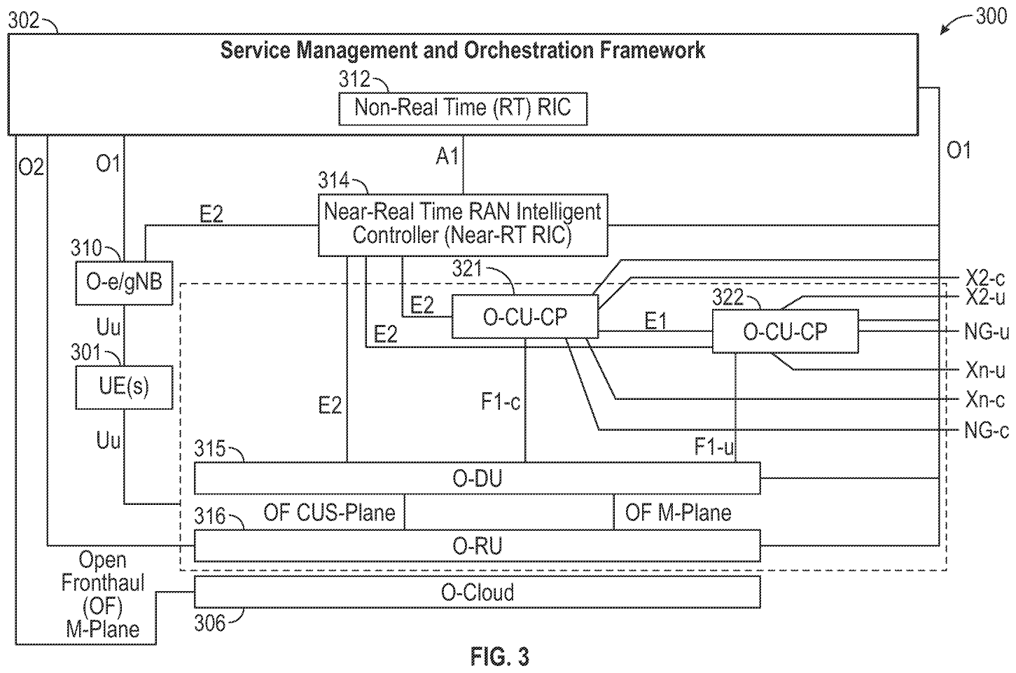

FIG. 3 shows an O-RAN logical architecture 300 corresponding to the O-RAN architecture 200 of FIG. 2. In FIG. 3, the SMO 302 corresponds to the SMO 202, O-Cloud 306 corresponds to the O-Cloud 206, the non-RT RIC 312 corresponds to the non-RT RIC 212, the near-RT RIC 314 corresponds to the near-RT RIC 214, and the O-RU 316 corresponds to the O-RU 216 of FIG. 2, respectively. The O-RAN logical architecture 300 includes a radio portion and a management portion.

The management portion/side of the architecture 300 includes the SMO Framework 302 containing the non-RT RIC 312 and may include the O-Cloud 306. The O-Cloud 306 is a cloud computing platform including a collection of physical infrastructure nodes to host the relevant O-RAN functions (e.g., the near-RT RIC 314, O-RAN Central Unit-Control Plane (O-CU-CP) 321, O-RAN Central Unit-User Plane (O-CU-UP) 322, and the O-RAN Distributed Unit (O-DU) 315), supporting software components (e.g., OSs, VMs, container runtime engines, ML engines, etc.), and appropriate management and orchestration functions.

The radio portion/side of the logical architecture 300 includes the near-RT RIC 314, the O-RAN Distributed Unit (O-DU) 315, the O-RU 316, the O-RAN Central Unit-Control Plane (O-CU-CP) 321, and the O-RAN Central Unit-User Plane (O-CU-UP) 322 functions. The radio portion/side of the logical architecture 300 may also include the O-e/gNB 310.

The O-DU 315 is a logical node hosting RLC, MAC, and higher PHY layer entities/elements (High-PHY layers) based on a lower-layer functional split. The O-RU 316 is a logical node hosting lower PHY layer entities/elements (Low-PHY layer) (e.g., FFT/iFFT, PRACH extraction, etc.) and RF processing elements based on a lower layer functional split. The O-CU-CP 321 is a logical node hosting the RRC and the control plane (CP) part of the PDCP protocol. The O O-CU-UP 322 is a logical node hosting the user-plane part of the PDCP protocol and the SDAP protocol.

### Intelligent User Burst Traffic Handling in V-RAN

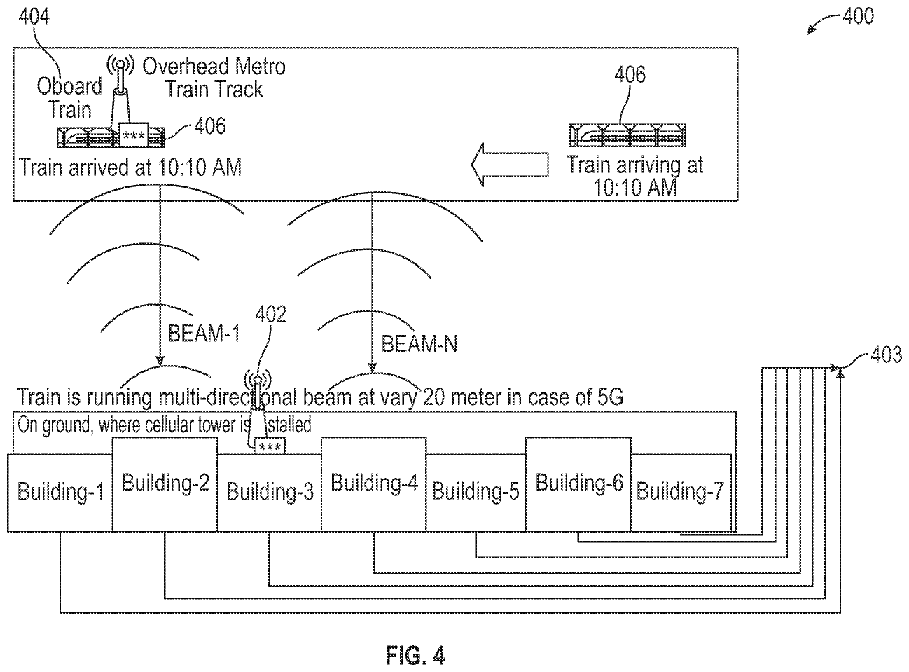

Any of the system architectures and networks described with respect to FIG. 1A-FIG. 3 can be implemented in locations within trains or other public transport, in cooperation with locations in surrounding buildings or neighborhoods. FIG. 4 illustrates a system 400 in which example aspects can be implemented. It will be understood that while FIG. 4 illustrates implementation in an O-RAN environment, other radio access technologies (RATs) can be used. In some examples,

As described earlier herein, large cities or population areas today can provide mass transportation. For example, metro train systems may transport several thousands of people daily, with several hundred or a thousand arriving at once at train depots or other transit centers periodically (e.g., every 10 minutes or on any other schedule) throughout the day. When these trains or other transport systems stop, communication systems 402 in the surrounding area may be placed under a brief but large communications burden, as passenger mobile devices attempt to connect to local communication systems. In examples, buildings 403 may have large numbers of users in them who would be adversely affected by theses surges.

Aspects of this disclosure address these and other concerns by providing communication services 404 on the trains 406 themselves. These communication services 404 can include V-RAN devices such as O-RU and O-DU devices similar to those described with reference to FIG. 1A-3, which can form a cell or base station.

Methods and systems according to aspects of the disclosure can identify the users (or their user equipment (UEs)) on any moving train 406 (or other vehicle) and move those UEs to the train communication services 404 by signaling those UEs to connect to train communication services. Methods and systems according to aspects can keep those identified UEs “camped” on the train communication services 404 for as long as the users are on board the train or other vehicle, and perhaps for a short time before and after the users are on board. Train V-RAN systems may have no or little impact on train power because trains typically include wired power lines, through which V-RAN (onboard train) to V-RAN (outside train) physical cables can be established.

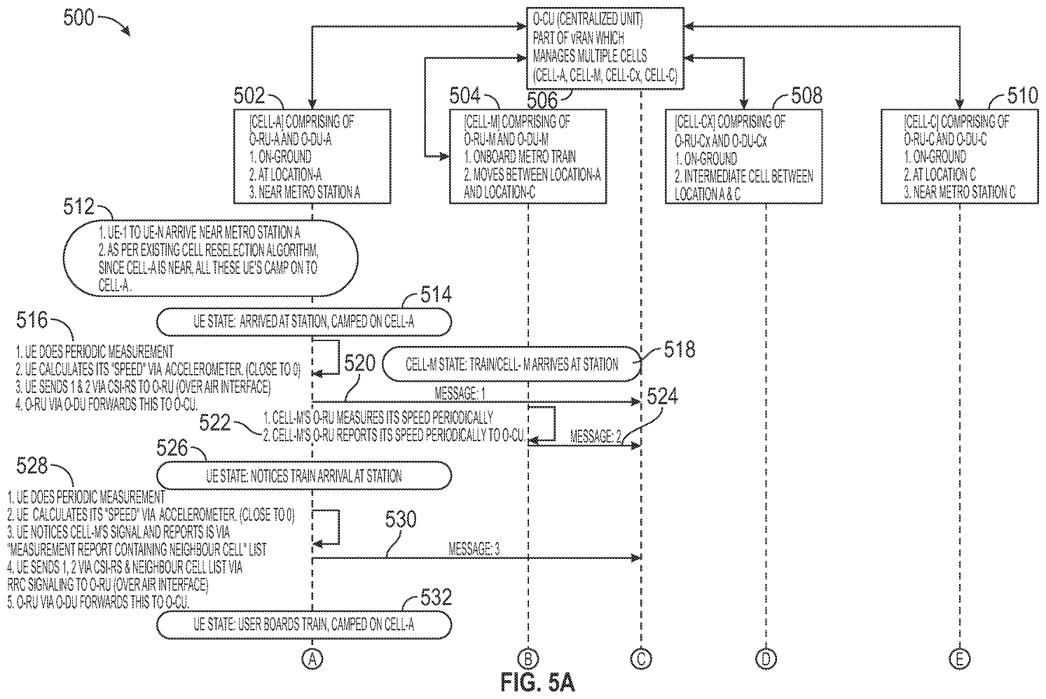

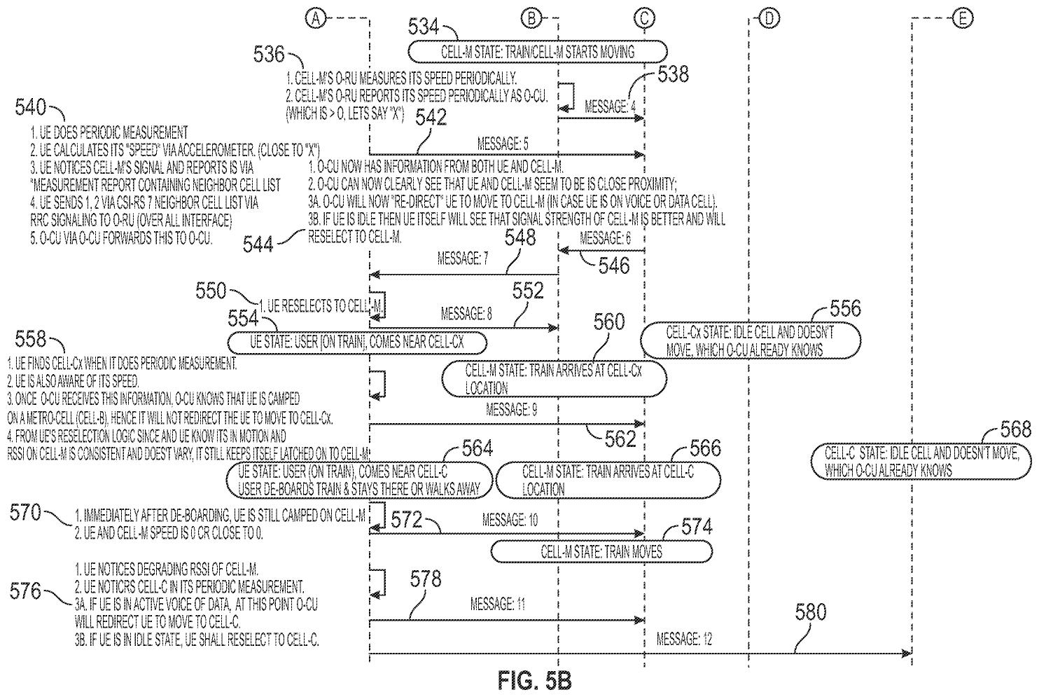

FIG. 5 illustrates signal flow 500 for implementing aspects of the disclosure. In the example of FIG. 5, two cells are visible/accessible to a UE: the first is cell 502, which can comprise an O-RU and O-DU as described earlier herein. Cell 502 may be stationary, for example on the ground (outside any train or other vehicle) and within communication range/inside a train station/depot.

Cell 504 may be on board the train or other vehicle, and similarly include an O-RU and O-DU. Both cell 502 and cell 504 can be connected to a common centralized unit or O-CU 506. Other cells 508, 510 can be nearby, for example cell 508 may be an intermediate cell along the path from cell 502 to cell 510. Cells 508, 510 may be stationary cells located, for example, along a train route, either along the rails, within intermediate stations, etc.

At point 512, a number of users (e.g., dozens, hundreds, one thousand or more) arrive at a train depot or other transit station. At point 514, the user/s can be standing stationary, awaiting the train, at which time the user/s mobile devices (e.g., UEs) will remain camped/connected to cell 502.

At 516, the UE/s can fetch, measure, or determine UE speed using, for example an accelerometer (although embodiments are not limited thereto). The UE/s can provide speed information over an air interface. Speed information can be provided using standard signaling, for example reference signals such as channel state information reference signals (CSI-RS) although embodiments are not limited thereto.

The signaling can also include neighboring cell information or other information that could be used in cell selection. The UE/s may not have information yet regarding the cell 504 information as cell 504 is too far away for UE connection. However, O-CU 506 will typically have information regarding cell 504 because O-CU 506 has information regarding any O-RUs or O-DUs controlled or centralized in O-CU 506. The UE/s will remain camped on cell 502 because conditions are still not favorable for connecting to cell 504.

At point 518, the train or other vehicle can arrive proximate the UE/s. One or more O-RUs (e.g., the O-RU associated with cell 502 and/or the O-RU associated with cell 504) can receive the UE speed at signal 520 and provide that speed to the O-CU 506 at signal 524. Upon receiving this speed at signal 524 the O-CU can measure, determine or receive the speed of the train by, for example direct measurement or signal 522 received from cell 504 (which is aboard the train).

Further, once UE/s notice/s that the train (or other vehicle) has arrived at point 526, the UE can perform periodic measurements at point 528. Measurements can include speed detections (which should still be zero or near zero as the user has not yet boarded the vehicle). Other measurements can include signal strength measured for cell 504, neighbor cell lists and corresponding strengths, and other measurements that could be used for cell selection. These and other measurements can be reported to the O-CU 506 at signal 530.

The O-CU 506 can compare cell 504 speed with speed indicated by the UE. If speed is equal or about equal, the UE is likely on the train that hosts cell 504. This comparison can continue once the UE boards the train at 532. At the time of boarding the UE may remain camped on cell 502, at least because the UE is still stationary (as is the train). Once the cell 504 begins moving at point 534, comparisons 536 can be made by the O-CU 506. Comparisons can be made based on cell 504 measurements including speed, which can be reported at signal 538. At this point cell 504 may appear in the UE neighbors list, which helps facilitate O-CU 506 comparison and analysis.

At 540, the UE can continue with periodic measurement and reporting of speed. The UE can also measure cell 504 signal strength and report this measurement to the O-CU 506 at signal 542. The cell 504 can also report measurements such that at 544, the O-CU 506 has access to information from both the UE and cell 504 (which the O-CU 506 can acknowledge in message 546), and the O-CU 506 can detect that the UE and cell 504 are in close proximity. The O-CU 506 can then command the UE to connect or camp on cell 504 in message 548 if the UE is in use (e.g., on a call) or the UE can connect on its own if the UE is in IDLE, and the UE can re-select to cell 504 at 550 as needed. Communications such as handover or other information can pass from cell 502 to cell 504 at signal 552. The UE can separately disconnect from cell 502 according to standard communication processes.

Once the user is on the train at 554, the UE can travel in proximity to other stationary cells such as cell 508. At 556, cell 508 may be idle and stationary, which is detected by O-CU 506.

At 558, the UE can make measurements of cell 508 and continue to report speed. The O-CU 506 can detect that the UE is traveling at the same speed as cell 504 and camped on cell 504; and therefore the O-CU 506 will not instruct the UE to connect to cell 508.

Once the UE arrives 560 at the station associated with cell 508 and de-boards the train, the O-CU 506 can detect that the UE speed is varying compared to cell 504 (this can also be signaled from the UE at signal 562) and that cell 508 is in the vicinity of UE (as per latest measurement report 558, which has cell 508 as a neighbor cell). The UE state as shown at 564 includes the user being on the train, but near stationary cell 508, and the user may either de-board the train and stay in the depot or walk away. The cell 504 state is shown at 566 and can be based on or known from the train (where cell 504 is mounted) approaching cell 508 location. Cell 508 state 568 can include being idle and not moving, which is already known by O-CU 506 since O-CU 506 has central control and knowledge.

If cell 504 begins to move away, the user will be in state 570 (wherein the UE may still be camped on cell 504, and UE speed and cell 504 speed will be at or near zero (user may be walking slowly or still standing in the station, train will be stationary)). Cell 502 can signal this and other status to O-CU 506 at signal 572 and at status 574 the train may begin to move (and therefore cell 504 will move along with the train). signal strength between the UE and cell 504 will be lowered relative to cell 508, as detected at 576, and the O-CU 506 will instruct the UE to connect to cell 508. If the UE does not de-board and stays on the train, the O-CU 506 will detect that the user is still in proximity to cell 504 and signal strength is not changing and no new connection command will be issued. Instead, the UE will remain connected to cell 504. Various reports can be made of these handovers at signals 578 and 580.

### Other Apparatuses and Description of Interfaces and Communications

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Referring again to FIG. 1A, the UEs 101 and 102 may be configured to connect, e.g., communicatively couple, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIG. 1). In this aspect, the S1 interface 113 is split into two parts: the S1-U interface 114, which carries user traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018 December). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server 160B, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

Referring again to FIG. 3, an E2 interface terminates at a plurality of E2 nodes. The E2 nodes are logical nodes/entities that terminate the E2 interface. For NR/5G access, the E2 nodes include the O-CU-CP 321, O-CU-UP 322, O-DU 315, or any combination of elements. For E-UTRA access the E2 nodes include the O-e/gNB 310. As shown in FIG. 3, the E2 interface also connects the O-e/gNB 310 to the Near-RT RIC 314. The protocols over the E2 interface are based exclusively on Control Plane (CP) protocols. The E2 functions are grouped into the following categories: (a) near-RT RIC 314 services (REPORT, INSERT, CONTROL, and POLICY, as described in O-RAN standards); and (b) near-RT RIC 314 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 3 shows the Uu interface between UE 301 and O-e/gNB 310 as well as between the UE 301 and O-RAN components. The Uu interface is a 3GPP-defined interface, which includes a complete protocol stack from L1 to L3 and terminates in the NG-RAN or E-UTRAN. The O-e/gNB 310 is an LTE eNB, a 5G gNB, or ng-eNB that supports the E2 interface. The O-e/gNB 310 may be the same or similar to other RAN nodes discussed previously. The UE 301 may correspond to UEs discussed previously and/or the like. There may be multiple UEs 301 and/or multiple O-e/gNB 310, each of which may be connected to one another via respective Uu interfaces. Although not shown in FIG. 3, the O-e/gNB 310 supports O-DU 315 and O-RU 316 functions with an Open Fronthaul interface between them.

The Open Fronthaul (OF) interface(s) is/are between O-DU 315 and O-RU 316 functions. The OF interface(s) includes the Control User Synchronization (CUS) Plane and Management (M) Plane. FIG. 2 and FIG. 3 also show that the O-RU 316 terminates the OF M-Plane interface towards the O-DU 315 and optionally towards the SMO 302. The O-RU 316 terminates the OF CUS-Plane interface towards the O-DU 315 and the SMO 302.

The F1-c interface connects the O-CU-CP 321 with the O-DU 315. As defined by 3GPP, the F1-c interface is between the gNB-CU-CP and gNB-DU nodes. However, for purposes of O-RAN, the F1-c interface is adopted between the O-CU-CP 321 with the O-DU 315 functions while reusing the principles and protocol stack defined by 3GPP and the definition of interoperability profile specifications.

The F1-u interface connects the O-CU-UP 322 with the O-DU 315. As defined by 3GPP, the F1-u interface is between the gNB-CU-UP and gNB-DU nodes. However, for purposes of O-RAN, the F1-u interface is adopted between the O-CU-UP 322 with the O-DU 315 functions while reusing the principles and protocol stack defined by 3GPP and the definition of interoperability profile specifications.

The NG-c interface is defined by 3GPP as an interface between the gNB-CU-CP and the AMF in the 5GC. The NG-c is also referred to as the N2 interface (see [O06]). The NG-u interface is defined by 3GPP, as an interface between the gNB-CU-UP and the UPF in the 5GC. The NG-u interface is referred to as the N3 interface. In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC. In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB. In O-RAN, Xn-c and Xn-u protocol stacks defined by 3GPP are reused and may be adapted for O-RAN purposes.

The E1 interface is defined by 3GPP as being an interface between the gNB-CU-CP (e.g., gNB-CU-CP) and gNB-CU-UP. In O-RAN, E1 protocol stacks defined by 3GPP are reused and adapted as an interface between the O-CU-CP 321 and the O-CU-UP 322 functions.

The O-RAN Non-Real Time (RT) RAN Intelligent Controller (RIC) 312 is a logical function within the SMO framework 202, 302 that enables non-real-time control and optimization of RAN elements and resources; AI/machine learning (ML) workflow(s) including model training, inferences, and updates; and policy-based guidance of applications/features in the Near-RT RIC 314.

In some embodiments, the non-RT RIC 312 is a function that sits within the SMO platform (or SMO framework) 302 in the O-RAN architecture. The primary goal of non-RT RIC is to support intelligent radio resource management for a non-real-time interval (i.e., greater than 500 ms), policy optimization in RAN, and insertion of AI/ML models to near-RT RIC and other RAN functions. The non-RT RIC terminates the A1 interface to the near-RT RIC. It will also collect OAM data over the O1 interface from the O-RAN nodes.

The O-RAN near-RT RIC 314 is a logical function that enables near-real-time control and optimization of RAN elements and resources via fine-grained data collection and actions over the E2 interface. The near-RT RIC 314 may include one or more AI/ML workflows including model training, inferences, and updates.

The non-RT RIC 312 can be an ML training host to host the training of one or more ML models. ML training can be performed offline using data collected from the RIC, O-DU 315, and O-RU 316. For supervised learning, non-RT RIC 312 is part of the SMO 302, and the ML training host and/or ML model host/actor can be part of the non-RT RIC 312 and/or the near-RT RIC 314. For unsupervised learning, the ML training host and ML model host/actor can be part of the non-RT RIC 312 and/or the near-RT RIC 314. For reinforcement learning, the ML training host and ML model host/actor may be co-located as part of the non-RT RIC 312 and/or the near-RT RIC 314. In some implementations, the non-RT RIC 312 may request or trigger ML model training in the training hosts regardless of where the model is deployed and executed. ML models may be trained and not currently deployed.

The A1 interface is between the non-RT RIC 312 (within or outside the SMO 602) and the near-RT RIC 314. The A1 interface supports three types of services, including a Policy Management Service, an Enrichment Information Service, and an ML Model Management Service.

In some embodiments, an O-RAN network node can include a disaggregated node with at least one O-RAN Radio Unit (O-RU), at least one O-DU coupled via an F1 interface to at least one O-CU coupled via an E2 interface to a RIC (e.g., RIC 312 and/or RIC 314).

As illustrated in FIG. 2 and FIG. 3, key interfaces in O-RAN (e.g., defined and maintained by O-RAN) include the following interfaces: A1, O1, O2, E2, Open Fronthaul M-Plane, and O-Cloud. O-RAN network functions (NFs) can be VNFs, VMs, Containers, and PNFs. Interfaces defined and maintained by 3GPP which are part of the O-RAN architecture include the following interfaces: E1, F1, NG-C, NG-U, X2, Xn, and Uu interfaces.

As illustrated in FIG. 2 and FIG. 3, the following O-RAN control loops may be configured:
(a) Loop-1: (O-DU Scheduler control loop) TTI msec level scheduling;
(b) Loop-2: (Near-RT RIC) 10-500 msec resource optimization; and
(c) Loop-3: (Non-RT RIC) Greater than 500 msec, Policies, Orchestration, and SON.

As illustrated in FIG. 2 and FIG. 3, the following O-RAN nodes may be configured:
(a)O-CU-CP: RRC and PDCP-C NFs (associated with Loop-2);
(b)O-CU-UP: SDAP and PDCP-U NFs (associated with Loop-2);
(c)O-DU: RLC, MAC, and PHY-U NFs (associated with Loop-1); and
(d) O-RU: PHY-L and RF (associated with Loop 1).

As illustrated in FIG. 2 and FIG. 3, the following O-RAN RIC components may be configured:
(a) Non-RT-RIC: Loop 3 RRM services (O1 and A1 interfaces); and
(b) Near-RT-RIC: Loop 2 RRM services (E2 interface).

As illustrated in FIG. 2 and FIG. 3, the following O-RAN interfaces may be configured:
(a) A1 interface is between Non-RT-RIC and the Near-RT RIC functions; A1 is associated with policy guidance for control-plane and user-plane functions; Impacted O-RAN elements associated with A1 include O-RAN nodes, UE groups, and UEs;
(b) O1 interface is between O-RAN Managed Element and the management entity; O1 is associated with Management-plane functions, Configuration, and threshold settings mostly OAM & FCAPS functionality to O-RAN network functions; Impacted O-RAN elements associated with O1 include mostly O-RAN nodes and UE groups (identified e.g. by S-NSSAI and slice ID), sometimes individual UEs (pending solution for UE identifiers);
(c) O2 interface is between the SMO and Infrastructure Management Framework; O2 is associated with the management of Cloud infrastructure and Cloud resources allocated to O-RAN, FCAPS for O-Cloud; Impacted O-RAN elements associated with O2 include O-Cloud, UE groups, and UEs;
(d) E2 interface is between Near-RT RIC and E2 node; E2 is associated with control-plane and user-plane control functions; Impacted O-RAN elements associated with E2 include mostly individual UEs, sometimes UE groups and E2 nodes;
(e) E2-cp is between Near-RT RIC and O-CU-CP functions. E2-up is between Near-RT RIC and O-CU-UP functions;
(f) E2-du is between Near-RT RIC and O-DU functions. E2-en is between Near-RT RIC and O-eNB functions; and
(g) Open Fronthaul Interface is between O-DU and O-RU functions; this interface is associated with CUS (Control User Synchronization) Plane and Management Plane functions and FCAPS to O-RU; Impacted O-RAN elements associated with the Open Fronthaul Interface include O-DU and O-RU functions.

As illustrated in FIGS. 1A-FIG. 3, the following 3GPP interfaces may be configured:
(a) E1 interface between the gNB-CU-CP and gNB-CU-UP logical nodes. In O-RAN, it is adopted between the O-CU-CP and the O-CU-UP.
(b) F1 interface between the gNB-CU and gNB-DU logical nodes. In O-RAN, it is adopted between the O-CU and the O-DU. F1-c is between O-CU-CP and O-DU functions. F1-u is between O-CU-UP and O-DU functions.
(c) The NG-U interface is between the gNB-CU-UP and the UPF in the 5GC and is also referred to as N3. In O-RAN, it is adopted between the O-CU-UP and the 5GC.
(d) The X2 interface connects eNBs or connects eNB and en-gNB in EN-DC. In O-RAN, it is adopted for the definition of interoperability profile specifications. X2-c is for the control plane. X2-u for a user plane.
(e) The Xn interface connects gNBs, and ng-eNBs, or connects ng-eNB and gNB. In O-RAN, it is adopted for the definition of interoperability profile specifications. Xn-c is for the control plane. Xn-u is for the user plane.
(f) The UE to e/gNB interface is the Uu interface and is a complete protocol stack from L1 to L3 and terminates in the NG-RAN. Since the Uu messages still flow from the UE to the intended e/gNB managed function, it is not shown in the O-RAN architecture as a separate interface to a specific managed function.

In example embodiments, any of the UEs or RAN network nodes discussed in connection with FIG. 1A-FIG. 3 can be configured to operate using the techniques discussed herein associated with multi-access traffic management in an O-RAN architecture.

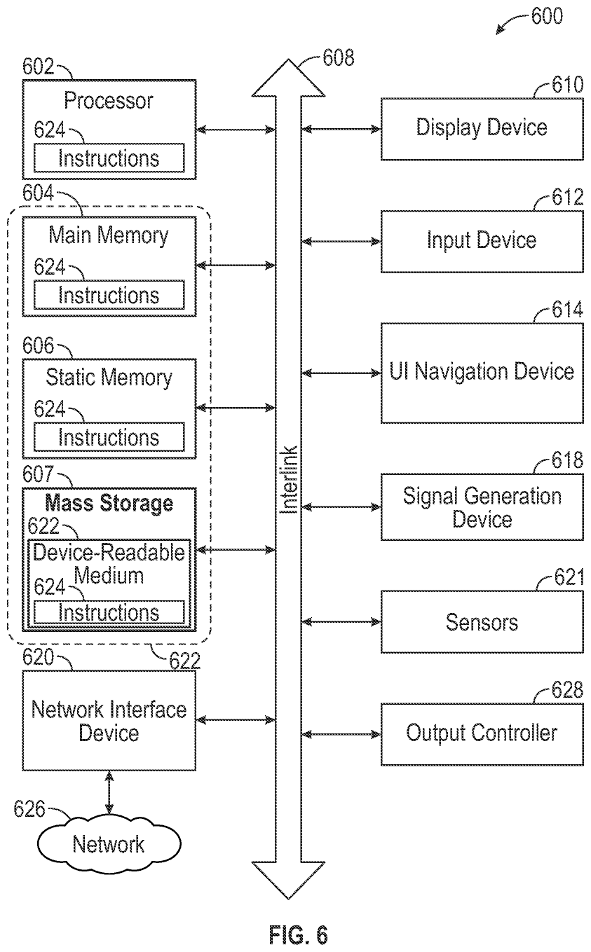

FIG. 6 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects and to perform one or more of the techniques disclosed herein. In alternative aspects, the communication device 600 may operate as a standalone device or may be connected (e.g., networked) to other communication devices.

The communication device may include a hardware processor 602 (e.g., a central processing unit (CPU), a graphics processing unit (GPU), a hardware processor core, or any combination thereof), a main memory 604, a static memory 606, and mass storage 607 (e.g., hard drive, tape drive, flash storage, or other block or storage devices), some or all of which may communicate with each other via an interlink (e.g., bus) 608.

The communication device 600 may further include a display device 610, an alphanumeric input device 612 (e.g., a keyboard), and a user interface (UI) navigation device 614 (e.g., a mouse). In an example, the display device 60, input device 612, and UI navigation device 614 may be a touchscreen display. The communication device 600 may additionally include a signal generation device 618 (e.g., a speaker), a network interface device 620, and one or more sensors 621, such as a global positioning system (GPS) sensor, compass, accelerometer, or another sensor. The communication device 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 607 may include a communication device-readable medium 622, on which is stored one or more sets of data structures or instructions 624 (e.g., software) embodying or utilized by any one or more of the techniques or functions described herein. In some aspects, registers of the processor 602, the main memory 604, the static memory 606, and/or the mass storage 607 may be, or include (completely or at least partially), the device-readable medium 622, on which is stored the one or more sets of data structures or instructions 624, embodying or utilized by any one or more of the techniques or functions described herein. In an example, one or any combination of the hardware processor 602, the main memory 604, the static memory 606, or the mass storage 607 may constitute the device-readable medium 622.

As used herein, the term “device-readable medium” is interchangeable with “computer-readable medium” or “machine-readable medium”. While the communication device-readable medium 622 is illustrated as a single medium, the term “communication device-readable medium” may include a single medium or multiple media (e.g., a centralized or distributed database, and/or associated caches and servers) configured to store the one or more instructions 624. The term “communication device-readable medium” is inclusive of the terms “machine-readable medium” or “computer-readable medium”, and may include any medium that is capable of storing, encoding, or carrying instructions (e.g., instructions 624) for execution by the communication device 600 and that causes the communication device 600 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 624 may further be transmitted or received over a communications network 626 using a transmission medium via the network interface device 620 utilizing any one of several transfer protocols. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one single-input-multiple-output (SIMO), MIMO, or multiple-input-single-output (MISO) techniques. In some examples, the network interface device 620 may wirelessly communicate using Multiple User MIMO techniques.

The term “transmission medium” shall be taken to include any intangible medium that is capable of storing, encoding, or carrying instructions for execution by the communication device 600, and includes digital or analog communications signals or another intangible medium to facilitate communication of such software. In this regard, a transmission medium in the context of this disclosure is a device-readable medium.

Example aspects of the present disclosure are further disclosed hereinbelow.

Example 1 is a network device comprising: a communications interface configured to receive communications from a user equipment (UE) and from a plurality of cells; and a processor coupled to the communications interface, the processor configured to: receive data, over the communications interface, indicating a speed of the UE and data indicating a mobile cell speed of at least one of the plurality of cells; and responsive to receiving an indication that the speed of the UE is within a threshold of the mobile cell speed, provide an instruction to the UE to connect to the mobile cell.

In Example 2, the subject matter of Example 1 can optionally include wherein the processor is configured to provide instructions to the UE to connect to the mobile cell if a signal strength between the UE and the mobile cell is above a threshold, and the speed of the UE is equal to the mobile cell speed.

In Example 3, the subject matter of Example 2 can optionally include wherein the processor is configured to provide an instruction to the UE to disconnect from the mobile cell when speed of the UE falls below a threshold or when the signal strength between the UE and the mobile cell falls below the threshold.

In Example 4, the subject matter of Example 3 can optionally include wherein the processor is configured to provide an instruction to the UE to connect to a stationary cell subsequent to disconnecting from the mobile cell.

In Example 5, the subject matter of Example 4 can optionally include wherein the processor is configured to provide an instruction to the UE to connect to a stationary cell having a highest signal strength as reported by the UE.

In Example 6, the subject matter of any of Examples 1-5 can optionally include wherein the network device is included in an Open-Radio Access Network (O-RAN) Centralized Unit (O-CU).

In Example 7, the subject matter of any of Examples 1-6 can optionally include wherein the communications interface communicates to a plurality of UEs based on detection of the plurality of UEs moving at a same speed.

Example 8 is an apparatus for use in an Open Radio Access Network (O-RAN) centralized unit (O-CU), the apparatus comprising: a processor, wherein to configure the O-CU for signal processing in an O-RAN network, the processor is to: detect speed in one or more connected devices, the one or more connected devices including at least one UE and at least one cell; and provide a connection command for the at least one UE to connect to at least one cell based on the speed of the at least one UE; and a memory coupled to the processor and configured to store connection information for the at least one UE and at least cell.

In Example 9, the subject matter of Example 8 can optionally include wherein at least one cell includes at least one vehicle cell traveling at a speed of a vehicle, and wherein the connection command is to connect to the at least one vehicle cell if the at least one UE is traveling at a same speed as the at least one vehicle cell.

In Example 10, the subject matter of Example 9 can optionally include wherein the apparatus is configured to receive signal strength information from at least one of the at least one UE and the at least one cell, and wherein the connection command is to disconnect from the vehicle cell responsive to the signal strength between the at least one UE and the vehicle cell falling below a threshold.

In Example 11, the subject matter of Example 9 can optionally include wherein the connection command is further to disconnect from the at least one vehicle cell responsive to the speed of the UE and the speed of the vehicle cell becoming mismatched.

In Example 12, the subject matter of Example 11 can optionally include wherein the processor is configured to provide a command to the UE to connect to a stationary cell subsequent to disconnecting from the vehicle cell.

In Example 13, the subject matter of Example 12 can optionally include wherein the processor is configured to provide an instruction to the UE to connect to a stationary cell having a highest signal strength as reported by the UE.

In Example 14, the subject matter of any of Examples 8-13 can optionally include wherein the processor communicates to a plurality of UEs based on detection of the plurality of UEs moving at a same speed.

Example 15 is a non-transitory computer-readable medium including instructions that, when executed on a processor, cause the processor to perform operations including any of Examples 1-14.

Example 15 is a system including means for performing any of Examples 1-14.

Although example aspects have been described herein, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. A network device comprising:
a communications interface configured to receive communications from a user equipment (UE) and from a plurality of cells; and
a processor coupled to the communications interface, the processor configured to:
receive data, over the communications interface, indicating a speed of the UE and data indicating a mobile cell speed of at least one of the plurality of cells; and
based on an indication that the speed of the UE is within a threshold of the mobile cell speed, provide an instruction to the UE to connect to the mobile cell.

2. The network device of claim 1, wherein the processor is configured to provide instructions to the UE to connect to the mobile cell if a signal strength between the UE and the mobile cell is above a threshold, and the speed of the UE is equal to the mobile cell speed.

3. The network device of claim 2, wherein the processor is configured to provide an instruction to the UE to disconnect from the mobile cell when speed of the UE falls below a threshold or when the signal strength between the UE and the mobile cell falls below the threshold.

4. The network device of claim 3, wherein the processor is configured to provide an instruction to the UE to connect to a stationary cell subsequent to disconnecting from the mobile cell.

5. The network device of claim 4, wherein the processor is configured to provide an instruction to the UE to connect to a stationary cell having a highest signal strength as reported by the UE.

6. The network device of claim 1, wherein the network device is included in an Open-Radio Access Network (O-RAN) Centralized Unit (O-CU).

7. The network device of claim 1, wherein the communications interface communicates to a plurality of UEs based on detection of the plurality of UEs moving at a same speed.

8. An apparatus for use in an Open Radio Access Network (O-RAN) centralized unit (O-CU), the apparatus comprising:
a processor, wherein to configure the O-CU for signal processing in an O-RAN network, the processor is to:
detect speed in one or more connected devices, the one or more connected devices including at least one UE and at least one cell;
provide a connection command for the at least one UE to connect to at least one cell based on the speed of the at least one UE; and
a memory coupled to the processor and configured to store connection information for the at least one UE and at least cell.

9. The apparatus of claim 8, wherein at least one cell includes at least one vehicle cell traveling at a speed of a vehicle, and wherein the connection command is to connect to the at least one vehicle cell if the at least one UE is traveling at a same speed as the at least one vehicle cell.

10. The apparatus of claim 9, wherein the apparatus is configured to receive signal strength information from at least one of the at least one UE and the at least one cell, and wherein the connection command is to disconnect from the vehicle cell responsive to the signal strength between the at least one UE and the vehicle cell falling below a threshold.

11. The apparatus of claim 9, wherein the connection command is further to disconnect from the at least one vehicle cell responsive to the speed of the UE and the speed of the vehicle cell becoming mismatched.

12. The apparatus of claim 11, wherein the processor is configured to provide a command to the UE to connect to a stationary cell subsequent to disconnecting from the vehicle cell.

13. The apparatus of claim 12, wherein the processor is configured to provide an instruction to the UE to connect to a stationary cell having a highest signal strength as reported by the UE.

14. The apparatus of claim 8, wherein the processor communicates to a plurality of UEs based on detection of the plurality of UEs moving at a same speed.

15. A non-transitory computer-readable medium including instructions that, when executed on a processor, cause the processor to perform operations including:
detecting speed in one or more connected devices, the one or more connected devices including at least one UE and at least one cell; and
providing a connection command for the at least one UE to connect to at least one cell based on the speed of the at least one UE.

16. The non-transitory computer-readable medium of claim 15, wherein at least one cell includes at least one vehicle cell traveling at a speed of a vehicle, and wherein the connection command is to connect to the at least one vehicle cell if the at least one UE is traveling at a same speed as the at least one vehicle cell.

17. The non-transitory computer-readable medium of claim 16, wherein operations further include receiving signal strength information from at least one of the at least one UE and the at least one cell, and wherein the connection command is to disconnect from the vehicle cell responsive to the signal strength between the at least one UE and the vehicle cell falling below a threshold.

18. The non-transitory computer-readable medium of claim 16, wherein the connection command is further to disconnect from the at least one vehicle cell responsive to the speed of the UE and the speed of the vehicle cell becoming mismatched.

19. The non-transitory computer-readable medium of claim 18, wherein instructions further include provide a command to the UE to connect to a selected stationary cell subsequent to disconnecting from the vehicle cell, the selected stationary cell having a highest signal strength as reported by the UE.

20. The non-transitory computer-readable medium of claim 15, wherein the operations further include communicating connection commands to a plurality of UEs based on detection of the plurality of UEs moving at a same speed.
